(19) United States
(12) Patent Application Publication
(10) Pub. No.: US 2012/0186998 A1
(43) Pub. Date: Jul. 26, 2012

(54) Microelectrode, Microelectrode formation, and methods of utilizing microelectrodes for charaterizing properties of localized environments and substrates

(76) Inventors: Andre Hermans, Doylestown, PA (US); R. Mark Wightman, Chapel Hill, NC (US)

(21) Appl. No.: 12/311,292

(22) PCT Filed: Sep. 18, 2007
(86) PCT No.: PCT/US2007/020143

§ 371 Date: Oct. 26, 2009

Related U.S. Application Data
(60) Provisional application No. 60/846,959, filed on Sep. 25, 2006.

(51) Int. Cl. C25B 11/04; C25D 5/02; G01N 27/26; C25F 1/00

(52) U.S. Cl. 205/780.5; 204/290.12; 205/661; 205/122; 205/775; 205/782; 205/792; 205/787.5

(57) ABSTRACT

Microelectrodes, microelectrode formation, and methods of utilizing microelectrodes for characterizing properties of localized environments and substrates are provided. A microelectrode can include a tungsten wire comprising a shaft and a conical tip. The conical tip can include an electroactive area. Further, the microelectrode can include an electroactive coating layer covering one or more surface of the tungsten wire. The tungsten wire surfaces can include a surface of the conical tip. An insulating layer can at least partially cover the shaft.

### RELATED APPLICATIONS

The presently disclosed subject matter claims the benefit of U.S. Provisional Patent Application Ser. No. 60/846,959, filed Sep. 25, 2006, the disclosure of which is incorporated herein by reference in its entirety.

### GOVERNMENT INTEREST

This presently disclosed subject matter was made with U.S. Government support under Grant No. NS15841 awarded by National Institute of Health (NIH). Thus, the U.S. Government has certain rights in the presently disclosed subject matter.

### TECHNICAL FIELD

The subject matter disclosed herein relates generally to electrodes. More particularly, the subject matter disclosed herein relates to microelectrodes, microelectrode formation, and methods of utilizing microelectrodes.

### BACKGROUND

Microelectrodes or ultramicroelectrodes have demonstrated advantages in a variety of applications. They can be used to probe chemistry in small volumes, to examine chemistry that occurs on a submicrosecond time scale, and to examine electrochemical reactions in solutions of very high resistance. These properties have made electrodes particularly useful for applications in biological systems, but also in other applications such as chromatography scanning-probe microscopy and photoelectrochemical processes.

Common substrates for volumetric microelectrodes are platinum, gold, and carbon. Microscopic platinum and gold wires and carbon fibers have been used to prepare microelectrodes. Typically, these materials are sealed into sealed soft glass capillaries, leaving a disk or cylindrical section of the conductor exposed. Epoxy resin can be used to seal any cracks between the fiber and the glass insulation. Diamond electrodes have been constructed by growing the diamond layer on etched stainless steel or tungsten microwires and insulating the shaft of the electrode to form a conical electrode. One disadvantage of glass capillaries is that they are not freely bendable and therefore difficult to manage in many applications.

Predating voltammetric microelectrodes are microelectrodes used by electrophysiologists for voltage sensing. For example, conical microelectrodes formed from wire with an etched tip and with lacquer or glass insulation can measure the electrical activity of a single neuron. The wire is typically made of tungsten, although other suitable metals may be used. Commercially available conical microelectrodes include tungsten electrodes insulated with paralene or epoxy resin, with an exposed tip formed by removing the insulation with a laser. Current microelectrodes may be unsuitable for voltammetric measurement because of the corrosion properties of exposed tungsten. The oxides produce large background currents that interfere with faradaic currents from species to solution. However, the use of tungsten microelectrodes is desirable because these microelectrodes have several useful physical attributes such as high rigidity and low brittleness. Such attributes make the use of tungsten advantageous over the use of carbon and glass rods. For these reasons, it would be beneficial to provide microelectrodes including metal wires of desirable physical attributes that are not susceptible to corrosion.

In view of the foregoing, it is desired to provide improved microelectrodes, microelectrode formation, and methods of utilizing microelectrodes.

### SUMMARY

In accordance with this disclosure, novel microelectrodes, microelectrode formation, and methods utilizing microelectrodes for characterizing properties of localized environments and substrates are provided.

It is an object of the present disclosure therefore to provide novel microelectrodes, microelectrode formation, and methods utilizing microelectrodes for characterizing properties of localized environments and substrates. This and other objects as may become apparent from the present disclosure are achieved, at least in whole or in part, by the subject matter described herein.

### BRIEF DESCRIPTION OF THE DRAWINGS

The subject matter described herein will now be explained with reference to the accompanying drawings of which:

FIGS. 1A-1D illustrate exemplary fabrication steps of a method for forming a microelectrode having a tungsten wire in accordance with an embodiment of the subject matter disclosed herein;

FIGS. 2A and 2B are scanning electron microscopy (SEM) images of microelectrodes having smooth and complete platinum and gold coatings, respectively, in accordance with embodiments of the subject matter described herein;

FIG. 2C is an SEM image of an etched tungsten wire coated with PPF in accordance with an embodiment of the subject matter described herein;

FIG. 2D is an SEM image of a microelectrode having EPDXYLITE® insulation with a slight bulge formed on the shaft of the wire;

FIGS. 3A-3F are graphs showing cyclic voltammograms for a platinum-plated tungsten microelectrode in accordance with the subject matter described herein and a glass-encased platinum disk microelectrode;

FIGS. 4A-4F are graphs showing cyclic voltammograms for a gold-plated tungsten microelectrode in accordance with the subject matter described herein and a glass-encased platinum disk microelectrode;

FIGS. 5A-5F are graphs showing cyclic voltammograms for a carbon microelectrode in accordance with the subject matter described herein and a glass-encased carbon-fiber disk microelectrode;

FIG. 6 is a circuit diagram of a voltage measuring amplifier including a microelectrode for recording voltage signals from a chemical species in a localized environment according to an embodiment of the subject matter described herein;

FIG. 7 is a flow chart of an exemplary process of characterizing a property of a localized environment according to an embodiment of the subject matter described herein; and

FIG. 8 is a flow chart of an exemplary process of characterizing a property of a localized environment according to an embodiment of the subject matter described herein.

### DETAILED DESCRIPTION

In accordance with the present disclosure, microelectrodes, microelectrode formation, and methods of utilizing microelectrodes for characterizing properties of localized environments and substrates are provided. The microelectrodes described herein can have particular application to detecting a presence of, an amount of, or a change in a chemical species in a localized environment, such as a biological sample. Further, the microelectrodes described herein can have particular application to characterizing properties of a substrate. Other applications of the microelectrodes disclosed herein include electrophysiological single cell recording, scanning-tunneling microscopy (STM), atomic force microscopy (AFM), and scanning-electrochemical microscopy (SECM).

A microelectrode in accordance with the subject matter disclosed herein can include a tungsten wire comprising a shaft and a conical tip. The conical tip can have an electroactive area. The microelectrode can also include an electroactive coating layer covering one or more surfaces of the tungsten wire. Particularly, the electroactive coating layer can cover a surface of the conical tip. An insulating layer can at least partially cover the shaft. By covering the tungsten surface with the insulating layer and electroactive coating layer, the risk of corrosion of the tungsten surface can be significantly reduced or prevented. As a result of reducing or preventing corrosion, the high quality of measurements obtained by the microelectrode can be sustained for long time periods. Tungsten wires have high tensile modulus and enable the fabrication of microelectrodes that have small dimensions overall while retaining rigidity. Other benefits of the microelectrodes and related methods disclosed herein will be apparent to those of skill in the art.

Tungsten wires are materials having high rigidity and low brittleness. The rigidity of a material can be quantified by the tensile modulus, which is the quotient of the tensile stress over the tensile strain. With a tensile modulus of 411 GPa, compared to 170 GPa for platinum and 78.5 GPa for gold, small tungsten wires are sufficiently stiff that they can be used in many applications without further support. Furthermore, tungsten wires are less brittle than carbon and glass rods of similar dimensions. Thus, tungsten wires can advantageously be formed with a tip having a small sensing area. In addition, the overall diameter of tungsten-based microelectrodes coated with an insulator can be much smaller than microelectrodes that use glass tubes as the insulating material.

In one embodiment of forming microelectrodes in accordance with the subject matter disclosed herein, voltammetric microelectrodes using tungsten wires as a substrate can be prepared. In one example, the microelectrodes include 125 μm tungsten wires having a conical tip. Gold or platinum-plated microelectrodes can be fabricated by use of tungsten microelectrodes that are completely insulated except at the tip. Oxides can be removed from the exposed tungsten. Next, platinum or gold can be electroplated for yielding surfaces with an electroactive area of between about 1×10⁻⁶ cm² and 2×10⁻⁶ cm². An insulating layer can also be applied to at least partially cover a shaft of the tungsten wire and/or the gold or platinum plating.

In another embodiment, microelectrodes having carbon surfaces on the etched tip of tungsten microwires can be fabricated. The fabrication process can include coating the etched tip with photoresist followed by pyrolysis. The entire microelectrode can then be insulated with EPDXYLITE® except for the tip, yielding an exposed carbon surface with an area of about 4×10⁻⁶ to about 6×10⁻⁶ cm². An insulating layer can also be applied to at least partially cover a shaft of the tungsten wire and/or the carbon surface.

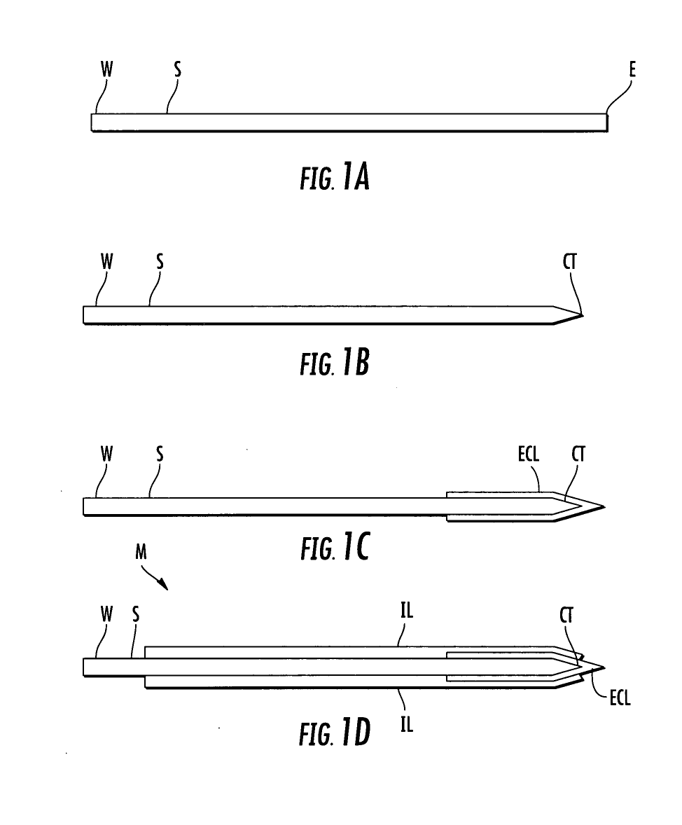

FIGS. 1A-1D illustrate exemplary fabrication steps of a method for forming a microelectrode having a tungsten wire in accordance with an embodiment of the subject matter disclosed herein. Referring to FIG. 1A, a straight tungsten wire W is provided. Wire W can be freely bendable and comprise a shaft S having a diameter of about 125 μm. In one example, the wire can be an uninsulated tungsten wire available from Advent Research Material, of Eynsham, England. In the alternate, the wire can have any other suitable size or dimensions. The wire can be about 99.5% tungsten and have a length of about 75 mm. For example, the dimensions of the wire can range between 50 and 250 μm in diameter. The use of tungsten can be beneficial because of its rigidity. Alternatively, the wire can be made of stainless steel.

Referring to FIG. 1B, a conical tip CT can be formed at an end of wire W. An alternating current (AC) etching technique can be applied to wire W for forming conical tip CT. In one embodiment, the conical tip can be prepared by etching in a saturated sodium nitrite solution containing 1 M NaOH at an AC potential of 10 V at 60 Hz. The counter electrode can be a stainless steel coil. The wire can be lowered slowly into the etching solution until gas evolution is observed and can be raised again when the gas evolution stops. In the alternate, conical tip CT can be formed by any other suitable technique, such as DC etching.

Oxides on surfaces of wire W, including surfaces of shaft S and conical tip CT, can be removed by any suitable technique. In one example, an exposed end E of wire W can be cleaned for about 10 seconds in hydrofluoric acid (48%), available from Sigma-Aldrich, of St. Louis, Mo. Further, wire W can be electrolyzed for 30 seconds at 50° C. in electrocleaning solution (e.g., an electrocleaning solution available from Shor International Corporation, of Mt. Vernon, N.Y.) at −5 V versus a platinum or gold counter electrode.

Referring to FIG. 1C, at least a portion of the surfaces of conical tip CT and shaft S can be covered with an electroactive coating layer ECL. For example, after cleaning of wire W, wire W can be rinsed with double-distilled water and transferred into a plating solution. For platinum plating, the plating solution can be Platinum TP PTU, 240451GL (available from Technic, Inc., of Cranston, R.I.). Platinum can be plated for 5 seconds at −0.5 V versus a platinum counter electrode at 50° C. After plating, wire W can be rinsed with double-distilled water and can then be used or stored in ethanol.

In one alternative to plating with platinum, wire W can be plated with gold. Wire W can be plated with gold using a technique similar to the platinum plating technique described above. For the cleaning and plating processes, a gold counter electrode can be used instead of platinum to minimize contamination. The plating of wire W can be conducted in a gold plating solution (e.g., gold plating solution 24 k Royale, available from Shor International Corporation) for 30 seconds at −1 V versus a gold counter electrode. The wire can be used or can be stored in ethanol.

In one embodiment, electroactive coating layer ECL can be carbon. For carbon tips, wire W can be coated with photoresist to form a photoresist film. Next, the photoresist film can be pyrolyzed for forming pyrolyzed photoresist film (PPF). The resulting photoresist film has electrochemical properties similar to those of glassy carbon.

Referring to FIG. 1D, a microelectrode generally designated M in accordance with the subject matter described herein is illustrated. An insulating layer IL can be applied to wire W for at least partially covering shaft S. Wire W can be dipped three times into photoresist (e.g., photoresist AZ P4330-RS, available from Clariant Corporation, of Sommerville, N.J.) in 5 minute intervals with a micromanipulator (e.g., the Burleigh INCHWORM® positioning system, available from Burleigh Instruments, Inc., of Fishers, N.Y.). Wire W can be pulled out of the photoresist at a speed of 2 mm/minute. Wire W can be transferred to a furnace oven fitted with a quartz tube. Forming gas (95% nitrogen and 5% hydrogen) can be flowed through the tube furnace at an approximate rate of 100 mL/min. The tube can be purged for 20 minutes at room temperature, and subsequently the temperature can be increased linearly for 100 minutes to 1000° C., held at 1000° C. for 2 hours, and then cooled to room temperature. To insulate wire W, conical tip CT can be masked with paraffin wax (mp 53-57). The paraffin wax can be melted in a heating coil positioned under a stereoscope.

Wire W can be carefully inserted into the paraffin wax with a micromanipulator to cover the desired surface area. Next, wire W can be pulled back from the wax, leaving a wax layer at the tip. The masked wires can then be dipped three times into EPDXYLITE® insulation (e.g., #6001, available from Atlanta Varnish Compounds, of St. Louis, Mo.) in 5 minute intervals with a micromanipulator at a speed of 2 mm/min. The resulting microelectrode can be cured standing with the tip up at 200° C. for 30 min. Excess wax can be removed with turpentine (e.g., Klean Strip turpentine, available from W. M. Barr & Co., Inc., of Memphis, Tenn.). Before use, the microelectrode can be soaked in 2-propanol purified with Norit A activated carbon for at least 20 minutes.

Microelectrode M has the physical properties of tungsten microwires and the voltammetric properties of commonly used microelectrode materials. In particular, microelectrode M is bendable and rigid over its whole length due to the use of tungsten wire W or any other suitably sized and shaped material. Further, microelectrode M can have the voltammetric properties of electroactive coating layer ECL, which may be platinum or gold or any other desired metal applied using a suitable electroplating technique.

Depending on the use of microelectrodes as described herein, an important goal during fabrication may be to minimize the resistance between the tungsten wire and the electroactive coating layer introduced during the electrochemical etching procedure. Particularly, tungsten metal can form a passivated oxide layer when exposed to oxygen. The oxide layer can cause instabilities in the tunneling current when used as an STM tip. Further, the oxide layer can add to the resistance between the tungsten and the deposited surface. The use of hydrofluoric acid to clean the tungsten wire as described above can dissolve surface tungsten oxides and thus minimize resistance between the tungsten wire and the electroactive coating layer. The covering of the tungsten wire with an electroactive coating layer and/or an insulating layer can significantly reduce or prevent the corrosion of the surface of the tungsten wire.

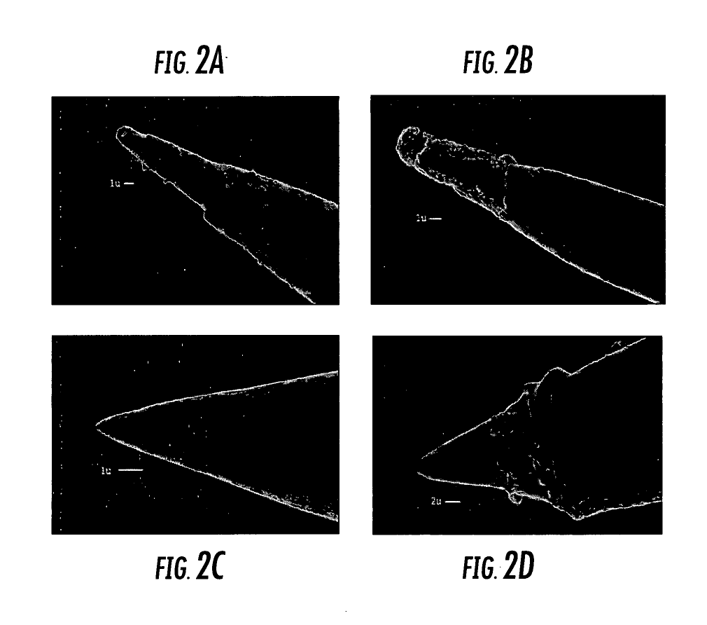

Another important goal during microelectrode fabrication may be to achieve a relatively smooth, complete, and durable deposition of the microelectrode surface. The tip of the tungsten wire can be plated with noble-metals including complex agents that buffer the free concentration of metal ions and promote the formation of a smooth surface. Plating variables such as temperature, plating time, and plating potential can be optimized for achieving a high-quality microelectrode surface and for avoiding dendritic growth or incomplete surface covering. The microelectrode formation techniques described herein can achieve a smooth microelectrode surface. For example, FIGS. 2A and 2B are scanning electron microscopy (SEM) images of microelectrodes having smooth and complete platinum and gold coatings, respectively, in accordance with embodiments of the subject matter described herein. Rougher surfaces were formed with gold coating at higher plating potentials due to dendritic growth. At lower plating potentials, plating can be incomplete. Dip-coating with photoresist, the carbon precursor, can require removal at a constant but slow speed to achieve complete coverage. PPFs can have very smooth surfaces on a tungsten-plated microelectrode. For example, FIG. 2C is an SEM image of an etched tungsten wire coated with PPF in accordance with an embodiment of the subject matter described herein.

Yet another important goal with microelectrode formation is to provide a microelectrode with an intact insulation layer. This can be accomplished using a variety of materials such as electrodeposited films, electrophoretic-paint, or a resin such as EPDXYLITE®. Microelectrodes having EPDXYLITE® insulation, as described herein, are stable when used in aqueous solution over the course of several days. Exposure to alcohols or nonoxidizing concentrated acids for several hours may not affect the insulation quality measured by the AC impedance of the electrode. EPDXYLITE® insulation can be stable in alkali as well as many organic solvents. Microelectrodes fabricated in accordance with the subject matter described herein underwent vibration testing and demonstrated to be sufficiently flexible to remain intact during testing. Direct physical impact, especially close to the exposed tip, or permanently bending the wire of the microelectrode can damage the insulation. For example, referring to FIG. 2D, an SEM image of a microelectrode having EPDXYLITE® insulation is shown with a slight bulge formed on the shaft of the wire. The bulge was formed from excess EPDXYLITE® that accumulated around the wax mask. During curing, the insulation can flow back and harden to function as reinforcement of the insulation close to the microelectrode tip. The size of the exposed area at the PPF microelectrodes can vary according to the size of the wax mask applied to the microelectrode tip.

The electrochemical performance of microelectrodes in accordance with the subject matter described herein was tested by comparing the cyclic voltammetric responses of the plated microelectrodes with the responses at conventional analogous glass-encased microelectrodes. For the platinum, gold, and carbon microelectrodes, cyclic voltammograms in background solution were obtained to compare the oxidation and reduction of the microelectrode material and to observe hydrogen and oxygen absorption and evolution. To characterize faradaic reactions, the reduction of ferricyanide and the oxidation of the water-soluble ferrocene compound ferrocenecarboxylic acid were used. For these analytes, background-subtracted fast-scan cyclic voltammograms and slow-scan voltammograms were recorded.

Cyclic voltammograms were acquired with the EI-400 potentiostat (available from Ensman Instrumentation, of Bloomington, Ind.). For background-subtracted cyclic voltammograms, the electrode was positioned at the outlet of a six-port rotary valve. A loop injector was mounted on an actuator controlled by a 12-V DC solenoid valve kit. This introduced the analyte to the electrode surface. Solution was driven with a syringe infusion pump through the valve and the electrochemical cell. A Ag—AgCl reference electrode was used. Fast-scan cyclic voltammograms were low-pass filtered with software at 5 kHz, and slow-scan measurements were filtered with a second-order low-pass hardware filter at 1 Hz. Steady-state currents obtained from slow-scan measurements were used to calculate the electroactive area of the microelectrodes.

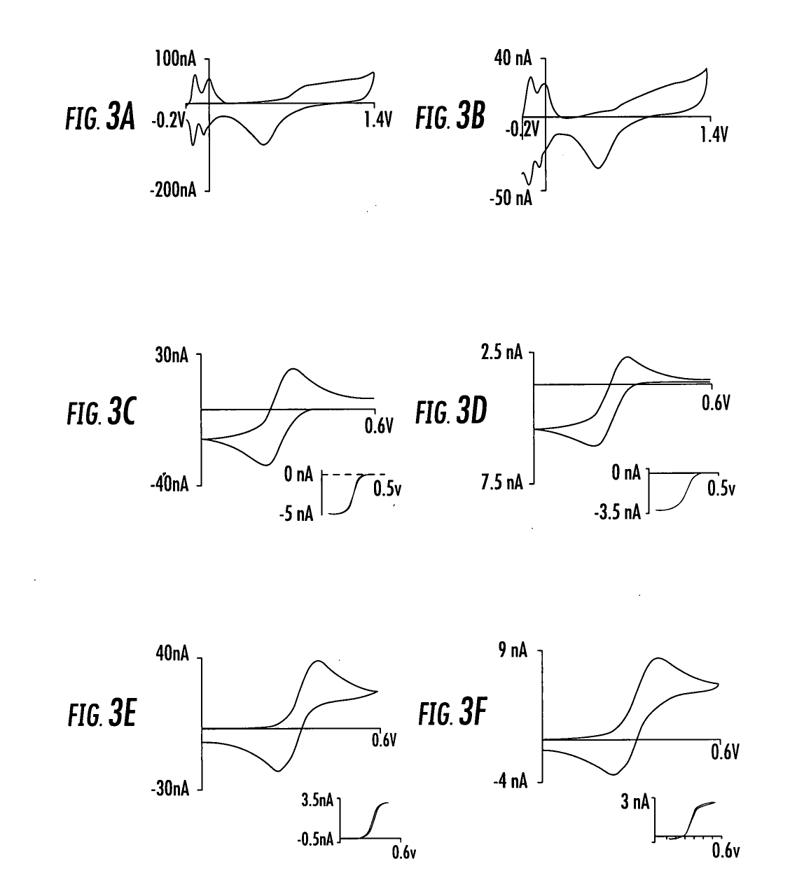

FIGS. 3A-3F are graphs showing cyclic voltammograms for a platinum-plated tungsten microelectrode in accordance with the subject matter described herein and a glass-encased platinum disk microelectrode. In particular, FIGS. 3A, 3C, and 3E represent cyclic voltammograms for the glass-encased platinum disk microelectrode. FIGS. 3B, 3D, and 3F represent cyclic voltammograms for the platinum-plated microelectrode. Referring to FIGS. 3A and 3B, a comparison is provided of the glass-encased platinum disk microelectrode and the platinum-plated tungsten microelectrode in tests with 0.5 M sulfuric acid at 10 V/s. The background response for the platinum-plated microelectrode is identical with the background response for the glass-encased platinum disk microelectrode. The peaks in the hydrogen region are well developed. The presence of clearly distinct peaks for the adsorption and desorption of hydrogen shows that the surface of the platinum-plated microelectrode is clean and useful for electroanalysis.

Referring to FIGS. 3C and 3D, a comparison is provided of the glass-encased platinum disk microelectrode and the platinum-plated tungsten microelectrode in tests with the background-subtracted cyclic voltammogram at 100 V/s for the injection of 1 mM ferricyanide in 1 M KCl. The insets of FIGS. 3C and 3D are the cyclic voltammograms for 1 mM ferricyanide in 1 M KCl at 10 mV/s. In FIG. 3C, peak separation ΔEₚ=73 mV and half-wave potential E_{1/2}=0.254 V vs Ag/AgCl. In FIG. 3D, peak separation ΔEₚ=83 mV and half-wave potential E_{1/2}=0.265 V vs Ag/AgCl.

Referring to FIGS. 3E and 3F, a comparison is provided of the glass-encased platinum disk microelectrode and the platinum-plated tungsten microelectrode in tests with the background-subtracted cyclic voltammogram at 100 V/s for the injection of 1 mM ferrocenedicarboxylic acid in 0.01 M phosphate buffer with 1 M KCl. The insets of FIGS. 3E and 3F are the cyclic voltammograms for 1 mm ferrocenedicarboxylic acid in 0.01 M phosphate buffer with 1 M KCl at 10 mV/s. In FIG. 3E, peak separation ΔEₚ=84 mV and half-wave potential E_{1/2}=0.317 V vs Ag/AgCl. In FIG. 3F, peak separation ΔEₚ=89 mV, and half-wave potential E_{1/2}=0.323 V vs Ag/AgCl.

Both ferricyanide and ferrocenedicarboxylic acid results illustrated in FIGS. 3C-3F show similar voltammetric responses at slow and fast-scan rates at the two platinum surfaces. The peak separation (ΔEₚ) for both analytes indicates similar electron-transfer kinetics. Slow-scan cyclic voltammograms show the sigmoidal shape and have a similar half-wave potential (E_{1/2}).

During the testing, 30 microelectrodes were plated with platinum, and approximately 90% showed well-behaved electrochemistry similar to that shown in FIGS. 3B, 3D, and 3F. For the remaining 10%, the slow-scan voltammograms exhibited resistive effects characterized by a severely ramping current. This result can be attributed to incomplete metal coverage of the underlying tungsten or a defect in the insulation. In these cases, replating often led to improved performance. The microelectrodes were used in several experiments and were cleaned between experiments by cycling to positive potentials.

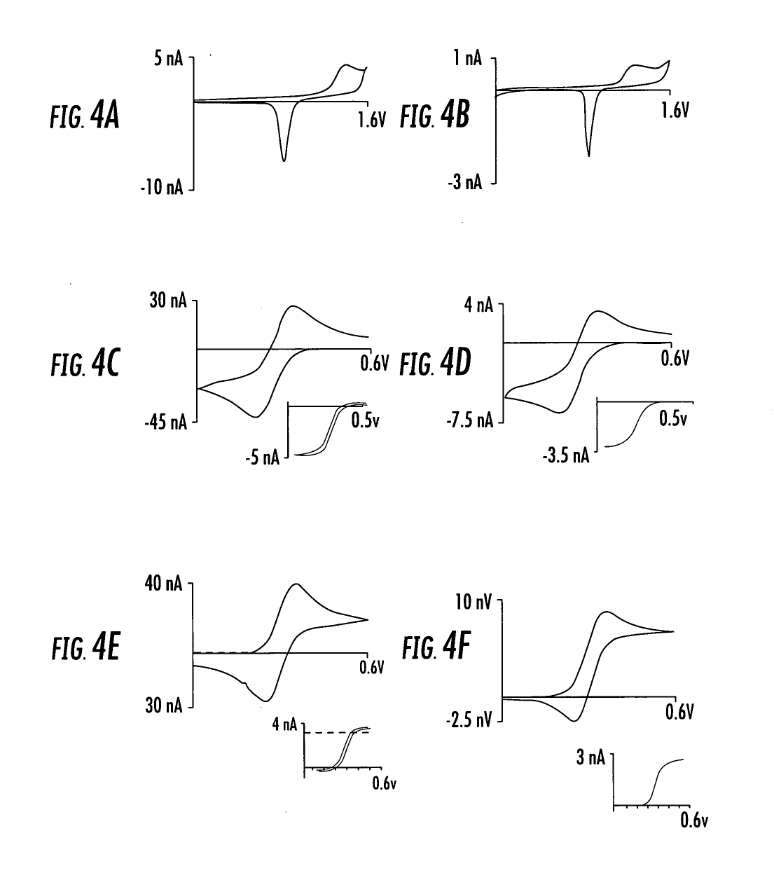

Similar to the platinum comparisons above, the electrochemical performance of gold-plated microelectrodes in accordance with the subject matter described herein was compared to a conventional analogous glass-encased platinum disk microelectrode. FIGS. 4A-4F are graphs showing cyclic voltammograms for a gold-plated tungsten microelectrode in accordance with the subject matter described herein and a glass-encased platinum disk microelectrode. In particular, FIGS. 4A, 4C, and 4E represent cyclic voltammograms for the glass-encased gold disk microelectrode. FIGS. 4B, 4D, and 4F represent cyclic voltammograms for the gold-plated microelectrode. Referring to FIGS. 4A and 4B, a comparison is provided of the glass-encased platinum disk microelectrode and the gold-plated tungsten microelectrode in tests with 0.1 M perchloric acid at 0.1 V/s. Referring to FIGS. 4A and 4B, the cyclic voltammogram obtained at gold-plated microelectrodes shows clearly defined oxidation and reduction peaks that are comparable to the cyclic voltammograms obtained at glass-encased platinum microelectrodes.

Referring to FIGS. 4C and 4D, a comparison is provided of the glass-encased platinum disk microelectrode and the gold-plated tungsten microelectrode in tests with the background-subtracted cyclic voltammogram at 100 V/s for the injection of 1 mM ferricyanide in 1 M KCl. The insets of FIGS. 4C and 4D are the cyclic voltammograms for 1 mM ferricyanide in 1 M KCl at 10 mV/s. In FIG. 4C, peak separation ΔEₚ=120 mV and half-wave potential E_{1/2}=0.277 V vs Ag/AgCl. In FIG. 4D, peak separation ΔEₚ=114 mV and half-wave potential E_{1/2}=0.259 V vs Ag/AgCl.

Referring to FIGS. 4E and 4F, a comparison is provided of the glass-encased platinum disk microelectrode and the gold-plated tungsten microelectrode in tests with the background-subtracted cyclic voltammogram at 100 V/s for the injection of 1 mM ferrocenedicarboxylic acid in 0.01 M phosphate buffer with 1 M KCl. The insets of FIGS. 4E and 4F are the cyclic voltammograms for 1 mm ferrocenedicarboxylic acid in 0.01 M phosphate buffer with 1 M KCl. In FIG. 4E, peak separation ΔEₚ=80 mV and half-wave potential E_{1/2}=0.316 V vs Ag/AgCl. In FIG. 4F, peak separation ΔEₚ=89 mV, and half-wave potential E_{1/2}=0.319 V vs Ag/AgCl.

The responses to the analytes shown in FIGS. 4C-4F are similar to the observation made at platinum-plated microelectrodes regarding electron transfer, diffusion, and surface coverage, as can be seen in similar peak separation (ΔEₚ) values for fast-scan measurements and similar half-wave potential (E_{1/2}) values for slow scans. Cleanliness and complete surface coverage may be harder to achieve by gold plating compared to platinum plating, as indicated by the rough coating shown in FIG. 2C. Alternative procedures such as vacuum deposition or sputtering of gold layers may result in smoother surfaces.

During testing, twenty microelectrodes were plated with a gold layer in this test. The success rate for gold microelectrodes was about 70%, lower than that for platinum plating. As with platinum, gold-plated microelectrodes could be recycled by stripping of the gold layer followed by replating. Successfully plated microelectrodes can be used over the course of several experiments.

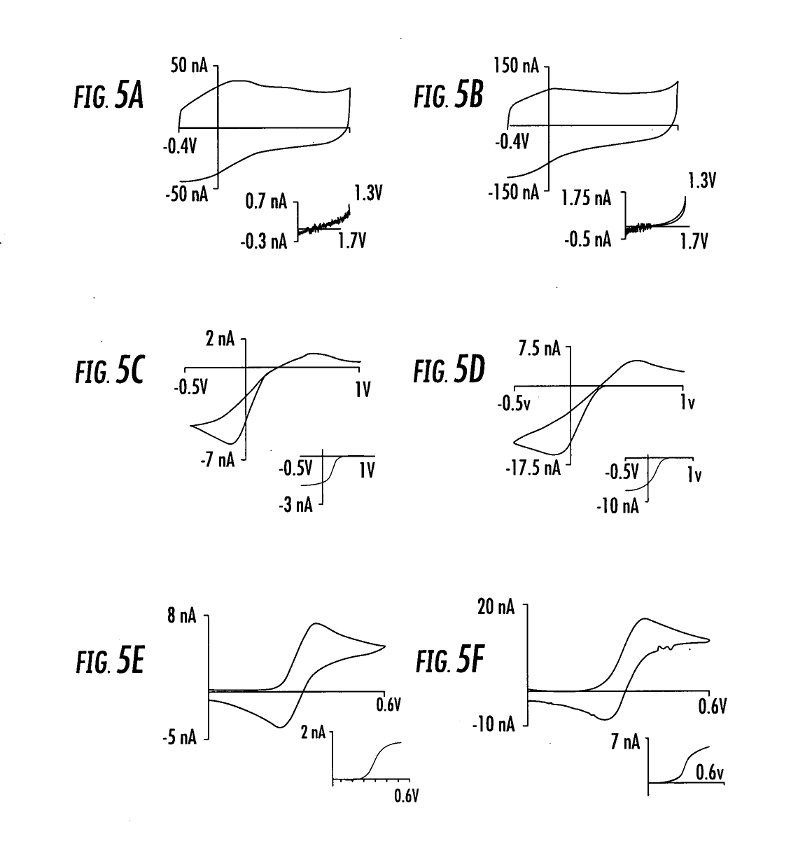

Similar to the comparisons described above, the electrochemical performance of carbon microelectrodes in accordance with the subject matter described herein, was compared to a conventional analogous glass-encased carbon-fiber disk microelectrode. FIGS. 5A-5F are graphs showing cyclic voltammograms for a carbon microelectrode in accordance with the subject matter described herein and a glass-encased carbon-fiber disk microelectrode. In particular, FIGS. 5A, 5C, and 5E represent cyclic voltammograms for the glass-encased carbon-fiber disk microelectrode prepared from PPF. FIGS. 5B, 5D, and 5F represent cyclic voltammograms for the carbon microelectrode. Referring to FIGS. 5A and 5B, a comparison is provided of the glass-encased carbon-fiber disk microelectrode and the carbon microelectrode based on fast-scan background voltammograms in physiological Tris buffer (pH 7.4). The insets of FIGS. 5A and 5B show slow-scan cyclic voltammograms recorded in sulfuric acid. Referring to FIGS. 5A and 5B, the slow-scan cyclic voltammograms show no significant oxidation or reduction features except for oxygen formation. At neutral pH and fast-scan rates, carbon-fiber microelectrodes exhibit features in the cyclic voltammogram due to change in the oxidation state of the oxygen-containing functional groups on the surface. These results can be observed on the anodic scan around 0.2 V versus Ag/AgCl and on the cathodic scan at −0.2 V versus Ag/AgCl. The glass-encased carbon-fiber microelectrode and the PPF microelectrode show these waves.

Referring to FIGS. 5C and 5D, a comparison is provided of the glass-encased carbon-fiber disk microelectrode and the carbon microelectrode in tests with the background-subtracted cyclic voltammogram at 100 V/s for the injection of 1 mM ferricyanide in 1 M KCl. The insets of FIGS. 5C and 5D are the cyclic voltammograms for 1 mM ferricyanide in 1 M KCl at 40 mV/s. In FIG. 5C, peak separation ΔEₚ=712 mV and half-wave potential E_{1/2}=0.219 V vs Ag/AgCl. In FIG. 5D, peak separation ΔEₚ=745 mV and half-wave potential E_{1/2}=0.205 V vs Ag/AgCl.

Referring to FIGS. 5E and 5F, a comparison is provided of the glass-encased carbon-fiber disk microelectrode and the carbon microelectrode in tests with the background-subtracted cyclic voltammogram at 100 V/s for the injection of 1 mM ferrocenedicarboxylic acid in 0.01 M phosphate buffer with 1 M KCl. The insets of FIGS. 5E and 5F are the cyclic voltammograms for 1 mm ferrocenedicarboxylic acid in 0.01 M phosphate buffer with 1 M KCl. In FIG. 5E, peak separation ΔEₚ=106 mV and half-wave potential E_{1/2}=0.334 V vs Ag/AgCl. In FIG. 5F, peak separation ΔEₚ=110 mV, and half-wave potential E_{1/2}=0.327 V vs Ag/AgCl.

The shape of the voltammogram for the ferricyanide at the carbon microelectrode is similar to that obtained at carbon-fiber microelectrodes. Electron transfer at carbon microelectrodes for ferricyanide has been shown to be relatively slow at untreated carbon microelectrodes. Slow kinetics may be due to surface contaminants, the microstructure of carbon, or surface oxidation. Overall, the responses for the analytes ferricyanide and ferrocenedicarboxylic acid at carbon microelectrodes and carbon-fiber microelectrodes show similar peak separation and half-wave potentials, indicating similar electron-transfer kinetics.

Twenty-five carbon-deposited microelectrodes were examined in this study. All microelectrodes with a full coverage of pyrolyzed photoresist, as observed under a stereoscope, resulted in functional microelectrodes. About 35% of the tungsten wires did not show complete coverage of the tungsten wire, especially at the tip. These microelectrodes exhibited highly resistive behavior or were not functional.

The electroactive area of the microelectrodes may be determined from the limiting current obtained from slow-scan cyclic voltammograms shown in FIGS. 2D, 2F, 3D, 3F, and 4D and 4F. For a disk microelectrode, the steady-state current can be calculated using the following equation:

$${i}_{disk}^{SS} = 4 nFDcr \qquad ( 1 )$$

where n is the number of electrons transferred, F is Faraday's constant, D is the diffusion coefficient of the analyte, c is the bulk concentration of the analyte, and r is the radius of the disk. The steady-state current at finite conical microelectrodes can be approximated by using the following equation:

$${i}_{cone}^{SS} = {i}_{disk}^{SS} [ A + {B ( RG - C )}^{D} ] \qquad ( 2 )$$

where i_{disk}^{SS} is the steady-state current of a disk microelectrode of equivalent radius (r); RG is the ratio of the radius of the base of the insulating sheath over the radius of the cone; and A, B, C, and D are numerical constants that depend on the aspect ratio, H, of the cone. H is defined as the height of the cone divided by the radius. Equation (2) above can be rewritten to yield the radius of the cone in the following equation:

$$r = \frac{{i}_{cone}^{SS}}{4 nFDc [ A + {B ( RG - C )}^{D} ]} \qquad ( 3 )$$

The insulating sheath can be very thin, so the value for RG may be taken as 1.1.

The electroactive areas for platinum- and gold-plated microelectrodes may be determined using equation (3) because these microelectrodes are primarily determined by the amount of uninsulated tungsten on the substrates. H for these microelectrodes was determined to be 4 (see FIG. 2A). For platinum and gold microelectrodes, the base radius was calculated with the term in brackets in equation (3) extrapolated from theoretical working curves to be equal to 3.25 for H=4 and RG=1.1. With the corresponding height calculated from the aspect ratio H, the surface area was calculated. For platinum conical microelectrodes, the area was 1.2±0.4×10⁻⁶ cm², and for gold the area was 1.4±0.4×10⁻⁶ cm² (errors given as standard deviations). The geometrical area, estimated from FIG. 2A, is 1×10⁻⁶ cm², in reasonable agreement with the electrochemical data. The gold-surface area was also estimated by calculating the amount of charge consumed by the reduction of the gold oxide layer in perchloric acid (see FIG. 4B) using a reported value of 400 μC/cm². This technique led to surface areas almost twice as large, presumably reflecting the surface roughness.

The current amplitudes from the PPF microelectrodes varied more than those of the platinum and gold microelectrodes because the exposed area depends on the wax mask applied to the tip, an imprecise procedure. To calculate the electrochemical area, an H of 3 (see FIG. 2C) was used. Areas of these microelectrodes varied from 1×10⁻⁶ to 10×10⁻⁶ cm², with the majority in the range of 4×10⁻⁶ to 6×10⁻⁶ cm². The electroactive areas for gold- or platinum-plated microelectrodes in accordance with the subject matter described herein can have surface areas ranging between about 1×10⁻¹⁰ cm² and about 2×10⁻⁴ cm². The electroactive areas for PPF microelectrodes in accordance with the subject matter described herein can have surface areas ranging between about 1×10⁻¹⁰ cm² and about 1×10⁻⁴ cm².

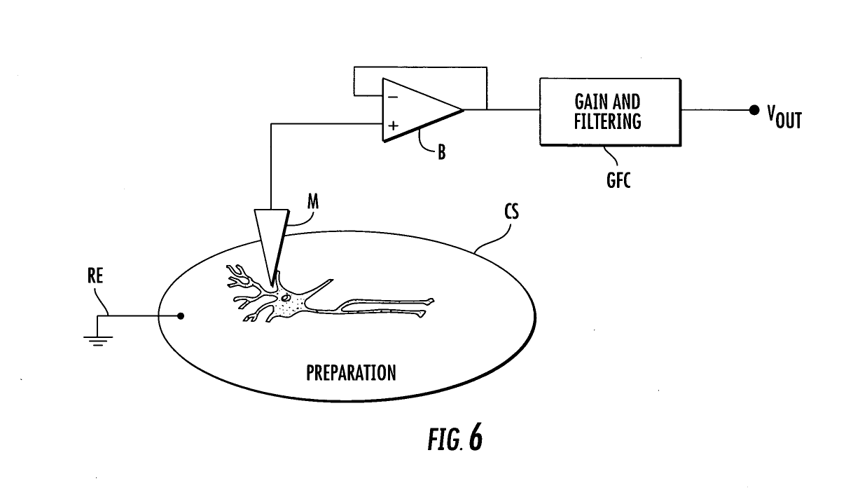

The microelectrodes disclosed herein can be utilized for applications in biological systems, chromatography scanning-probe microscopy, photoelectrochemical processes, and related applications. Particularly, the microelectrodes disclosed herein can be utilized in combination with electrochemical sensing circuitry for sensing chemical species current flow or voltage potential. FIG. 6 is a circuit diagram of a voltage measuring amplifier including microelectrode M for recording voltage signals from a chemical species CS in a localized environment according to an embodiment of the subject matter described herein. Referring to FIG. 6, microelectrode M can be positioned in or in close proximity to chemical species CS. Microelectrode M can be connected to a noninverting input of a voltage follower or operational amplifier (OP AMP) buffer B. An output of buffer B can be connected to an input of gain and filtering circuitry GFC for conditioning the output of buffer B. The output of circuitry GFC can be connected to node Vₒᵤₜ for analysis and recording. A reference electrode RE can be a Ag—AgCl reference electrode (available from Bioanalytical Systems, Inc., of West Lafayette, Ind.) suitably connected to analysis equipment and positioned in chemical species CS. A counter electrode can be connected to chemical species CS for comparison to the voltage at microelectrode M.

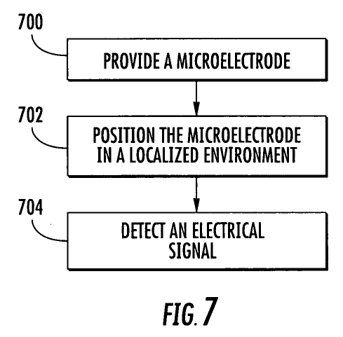

FIG. 7 is a flow chart illustrating an exemplary process of characterizing a property of a localized environment according to an embodiment of the subject matter described herein. In one example, a presence of, an amount of, or a change in chemical species CS shown in FIG. 6 can be detected by the process. Referring to FIGS. 6 and 7, microelectrode M can be provided (block 700) and can be positioned within chemical species CS (block 702). Further, reference electrode RE can be suitably positioned in chemical species CS. The localized environment can be contacted by the electroactive area of microelectrode M. The chemical species can be contained in an electrochemical cell placed inside a grounded Faraday cage to minimize electrical noise.

The localized environment can comprise a chemical species including one or more of dopamine, norepinephrine, epinephrine, nitric oxide, glutamate, gamma-aminobutyric acid (GABA), choline, acetylcholine, glucose, molecular oxygen, 4-hydroxy-3-methoxyphenylethylamine, serotonin, dihydroxyphenylacetic acid, homovanilic acid, hydroxyindole acetic acid, ascorbic acid, uric acid, or any other suitable chemical species. Further, the localized environment can be a biological sample including one or more of a cell, a cell membrane, a cell extract, a cell culture, a tissue, a tissue extract, a biological fluid, a living subject, and a single cell.

In block 704, an electrical signal generated by microelectrode M can be detected using the voltage measuring amplifier. In particular, a voltage across microelectrode M and reference electrode RE can be measured. Gain and filtering circuitry GFC can amplify and filter voltage signals sensed by microelectrode M. The resulting voltage signals can be output to node Vₒᵤₜ for analysis and recording.

The electrical signal can represent a characteristic of the localized environment. For example, the electrical signal can indicate a change in pH in the localized environment. In addition, the amplitude of the signal is proportional to the local concentration of species detected. The shape of the waveform is an indicator of the type of molecule detected. Molecular species that can be detected include catecholamines, serotonin, and their metabolites, as well as oxygen.

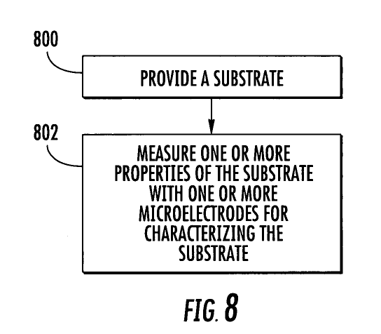

FIG. 8 is a flow chart illustrating an exemplary process of characterizing a property of a localized environment according to an embodiment of the subject matter described herein. Referring to FIG. 8, a substrate may be provided (block 800). Example substrates can include a single biological cell, a slice of brain tissue, or the brain of an anesthetized or freely moving animal.

In block 802, one or more properties of the substrate can be measured with one or more microelectrodes for characterizing the substrate. In one example, one or more of the microelectrodes can be a microelectrode such as microelectrode M shown in FIG. 1D. The properties can be measured using any suitable technique such as STM, AFM, and SECM. The microelectrode can be utilized as an electrical probe in STM, AFM, and SECM. The measurement can characterize a chemical property and an electrophysiological property of the substrate. Further, a plurality of microelectrodes can be present in an array format where a local chemical property is characterized over a broad anatomical region.

Microelectrodes in accordance with the subject matter described herein can be applied to detect characteristics of neurochemicals in the brain. A triangular voltage can be applied to the microelectrode and the resulting current detected. For example, a triangular voltage of 10 Hz and 1.3 V can be applied. The shape of the current response can be used to identify the molecules detected. The amplitude is proportional to the concentration.

Other applications of the electrodes disclosed herein may include the evaluation of the surface composition of a substrate using the electrodes in a scanning electrochemical microscope, atomic force microscope, or similar scanning microscopy technique.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A microelectrode comprising:
a tungsten wire comprising a shaft and a conical tip, the conical tip comprising an electroactive area;
an electroactive coating layer covering one or more surfaces of the tungsten wire, wherein the one or more surfaces of the tungsten wire comprises a surface of the conical tip; and
an insulating layer at least partially covering the shaft.

2. The microelectrode of claim 1, wherein the shaft has a diameter of about 125 μm.

3. The microelectrode of claim 1, wherein the electrode is freely bendable.

4. The microelectrode of claim 1, wherein the coating layer is selected from the group consisting of platinum, gold, and pyrolyzed photoresist film.

5. The microelectrode of claim 4, wherein the coating layer is platinum or gold, and the electroactive area has a surface area of between about 1×10⁻¹⁰ cm and about 2×10⁻⁴ cm².

6. The microelectrode of claim 4, wherein the coating layer is pyrolyzed photoresist film, and the electroactive area has a surface area of between about 1×10⁻¹⁰ cm² and about 1×10⁻⁴ cm².

7. A method of forming a microelectrode, the method comprising:
providing a tungsten wire comprising a conical tip and a shaft;
cleaning the conical tip to remove a layer of tungsten oxide; and
depositing an electroactive coating layer to cover one or more surfaces of the tungsten wire, the one or more surfaces of the tungsten wire comprising a surfaces of the conical tip, thereby forming an electroactive area on the surfaces of the conical tip.

8. The method of claim 7, wherein the cleaning step comprises:
contacting the conical tip with a first solution for a first period of time, the first solution comprising an acid; and
electrolyzing the conical tip in a second solution for a second period of time.

9. The method of claim 8, wherein the providing step comprises providing an insulated tungsten microelectrode comprising an exposed conical tip.

10. The method of claim 9, wherein the depositing comprises one of electroplating, vacuum deposition, and sputtering.

11. The method of claim 10, wherein the depositing comprises electroplating in one of the group consisting of a gold plating solution and a platinum plating solution.

12. The method of claim 8, wherein the providing step comprises providing an uninsulated tungsten wire comprising a shaft and further comprises forming a conical tip at one end of the shaft by electrochemically etching the one end, and wherein the depositing step comprises:
dipping the tungsten wire into a solution comprising a photoresist material, thereby coating the conical tip with the photoresist material;
heating the tungsten wire to pyrolyze the photoresist material, thereby forming a pyrolized photoresist film; and
insulating the shaft of the tungsten wire.

13. The method of claim 12, wherein the insulating step comprises:
providing a masking layer to cover the pyrolyzed photoresist film;
coating the shaft with a layer of insulating material; and
removing the masking layer.

14. A method of characterizing a property of a localized environment, the method comprising:
positioning a microelectrode within a localized environment, the microelectrode comprising:
a tungsten wire comprising a shaft and a conical tip, the conical tip comprising an electroactive area;
an electroactive layer covering one or more surface of the tungsten wire, wherein the one or more surface of the tungsten wire comprises a surface of the conical tip; and
an insulating layer covering at least a portion of the shaft; and
detecting an electrical signal generated by the microelectrode, the electrical signal representing a characteristic of the localized environment.

15. The method of claim 14, wherein the localized environment comprises a chemical species.

16. The method of claim 15, wherein the chemical species is selected from the group consisting of dopamine, norepinephrine, epinephrine, nitric oxide, glutamate, gamma-aminobutyric acid (GABA), choline, acetylcholine, glucose, molecular oxygen, 4-hydroxy-3-methoxyphenylethylamine, serotonin, dihydroxyphenylacetic acid, homovanilic acid, hydroxyindole acetic acid, ascorbic acid, and uric acid.

17. The method of claim 14, wherein the localized environment is a biological sample selected from the group consisting of a cell, a cell membrane, a cell extract, a cell culture, a tissue, a tissue extract, and a biological fluid.

18. The method of claim 17, wherein the sample is in a living subject.

19. The method of claim 18, wherein the sample is a single cell.

20. The method of claim 14, wherein detecting the electrical signal comprises detecting a change in pH in the localized environment.

21. The method of claim 14, further comprising contacting the localized environment with the electroactive area.

22. A method of characterizing one or more properties of a substrate, the method comprising:
providing a substrate; and
measuring one or more properties of the substrate with one or more microelectrodes for characterizing the substrate, each of the one or more microelectrodes comprising:
a tungsten wire comprising a shaft and a conical tip, the conical tip comprising an electroactive area;
an electroactive layer covering one or more surface of the tungsten wire, wherein the one or more surfaces of the tungsten wire comprises a surface of the conical tip; and
an insulating layer covering at least a portion of the shaft.

23. The method of claim 22, wherein measuring one or more properties of the substrate comprises utilizing the microelectrode with a technique selected from the group consisting of scanning-tunneling microscopy (STM), atomic force microscopy (AFM), and scanning-electrochemical microscopy (SECM).

24. The method of claim 22, wherein the characterizing comprises simultaneously characterizing a chemical property and an electrophysiological property of the substrate.

25. The method of claim 22, wherein the one or more microelectrodes comprises a plurality of microelectrodes, the plurality of microelectrodes being present in an array format, and wherein the characterizing comprises characterizing a local chemical property over a broad anatomical region.
